(19) United States
(12) Patent Application Publication
(10) Pub. No.: US 2025/0390782 A1
(43) Pub. Date: Dec. 25, 2025

(54) TOKEN POOLING FOR MACHINE LEARNING WITH INCREASED EXPRESSIVITY

(71) Applicant: QUALCOMM Incorporated, San Diego, CA (US)

(72) Inventors: Jamie Menjay LIN, San Diego, CA (US); Jian SHEN, San Diego, CA (US); Risheek GARREPALLI, San Diego, CA (US); Vikram GUPTA, San Diego, CA (US)

(21) Appl. No.: 18/747,947

(22) Filed: Jun. 19, 2024

(51) Int. Cl. G06N 20/00

(52) U.S. Cl. CPC G06N 20/00

(57) ABSTRACT

Certain aspects of the present disclosure provide techniques and apparatus for machine learning. In an example method, a feature map comprising a set of tokens is accessed for a pooling operation in a machine learning model, the feature map indicating correlation among a set of tensors. A polarized pooling operation is applied to the feature map to generate a pooled output, comprising, for each respective patch of a set of patches in the feature map, selecting a token, in the respective patch, having a highest absolute value. The pooled output is output.

### INTRODUCTION

Aspects of the present disclosure relate to machine learning.

A wide variety of machine learning model architectures have been developed to perform a variety of tasks, including generation of data such as text, images, video, audio, and the like, entity classification or detection, value or probability regression, and many others. Many modern model architectures, such as transformer-based models, rely on attention operations to process input. For example, many models use self-attention to improve the accuracy and reliability of the output predictions and/or generated data. Generally, attention mechanisms have proven to be useful in a wide variety of tasks, including diffusion models, large language models (LLMs), large vision models (LVMs), large multimodal models (LMMs), and the like.

In some models, attention mechanisms can be used to force active interactions among global and/or local features or tokens (e.g., with layers or stages of self-attention and/or cross-attention) within the data. In many cases, token pooling is used to facilitate the attention mechanism (e.g., across pyramid levels, patches, and/or scopes).

### BRIEF SUMMARY

Certain aspects of the present disclosure provide a processor-implemented method, comprising: accessing a feature map comprising a set of tokens for a pooling operation in a machine learning model, the feature map indicating correlation among a set of tensors; applying a polarized pooling operation to the feature map to generate a pooled output, comprising, for each respective patch of a set of patches in the feature map, selecting a token, in the respective patch, having a highest absolute value; and outputting the pooled output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for polarized token pooling in machine learning models, according to some aspects of the present disclosure.

FIG. 2 depicts an example workflow for performing polarized pooling using two maximum pooling operations, according to some aspects of the present disclosure.

FIG. 3 depicts an example architecture for performing polarized pooling using hardware operations, according to some aspects of the present disclosure.

FIG. 4 is a flow diagram depicting an example method for performing polarized pooling using two maximum pooling operations, according to some aspects of the present disclosure.

FIG. 5 is a flow diagram depicting an example method for performing polarized pooling using hardware, according to some aspects of the present disclosure.

FIG. 6 is a flow diagram depicting an example method for polarized pooling, according to some aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning via more expressive token pooling. Specifically, in some aspects of the present disclosure, a polarized pooling operation is provided that retains improved feature expressivity and can substantially improve model accuracy.

Attention mechanisms often play a large role in improving the accuracy of machine learning models. As discussed above, such attention mechanisms often rely on pooling operations to provide or facilitate at least some of these benefits. In particular, the high-frequency features often play important roles in model accuracy, and the loss of such information may lead to inferior accuracy for attention mechanisms across multiple levels. However, some conventional attention mechanisms are insufficiently expressive, and fail to account or provide for different types of attention, potentially reducing model accuracy and performance. For example, an attention model may be characterized by its capability to perform attention in the input or latent features. However, not all attentions are definitively “good” attentions. For example, a model, while being tasked or trained to attend to a first feature, may in some cases undesirably attend to a second (unrelated) feature. As another example, there may be important differences between positive attention and negative attention, desirable attention or undesirable attention, “good” attention or “bad” attention, and/or attention as opposed to distraction. Some conventional approaches do not differentiate these attentions, and do not address such concerns.

Additionally, an increasingly important problem that many recent generative artificial intelligence (AI) model developers (e.g., developers of diffusion models, LLMs, LVMs, and/or LMMs) are facing is model unlearning. That is, although models may learn, through the training dataset, by minimizing loss against the prepared ground truth(s), the learned model behavior may not fully comply with what developers expect or prefer in all scenarios. For example, recently, several large model developers have been forced to pause use of such models due to potentially offensive outputs (e.g., images and/or text that is offensive or inappropriate). While it may be desirable to perform “unlearning” or erasing a part of what has been learned by the model, some conventional attention operations make this unlearning virtually impossible.

In machine learning models, the activations (often in an aggregated form of a tensor, matrix, or vector) are effectively features that represent or carry “learned” insights from the inputs. Tokens may refer to features after being “tokenized” through the attention operation (e.g., query (Q), key (K), and value (V) matrices). In some aspects of the present disclosure, the terms “token” and “feature” may be used interchangeably. In attention mechanisms, feature interactions are provided to allow the features to “attend” to each other (often in the form of tensor (e.g., matrix) multiplication). Specifically, a vector at a given spatial coordinate of one tensor may be selected to correlate with another vector from another tensor (along with suitable normalization in some aspects). That is, two tensors are processed using an attention mechanism to generate a feature map indicating correlation between the tensors, and the feature map may then be processed using a normalization operation.

For example, many attention mechanisms use the normalized cross-correlation (NCC) operation. Many normalization operations, such as NCC, generate output values in the range of [−1,1], where the extreme values of −1 and 1 indicate the “maximum” degree of correlation (in opposite directions) and a value of 0 indicates the “minimum” (e.g., no) correlation.

As used herein, the term “definite value” is used to indicate values having a theoretically “perfect” physical meaning. For example, for the NCC operation, there are three such definite values: −1 (indicating perfect inverse correlation between the elements), 0 (indicating precisely no correlation), and 1 (indicating perfect correlation), as discussed above. As used herein, feature “expressivity” refers to the number of definite values the feature can have. For example, if the feature is the output of an NCC operation, the feature may be said to have an expressivity of three. In practice, the feature correlations may rarely reach these definite values, but the values are often relatively close to these “perfect” extrema (e.g., within a relatively small amount of noise).

In many conventional models, a variety of pooling operations are used to aggregate or combine the normalized features. For example, many current models rely on maximum pooling (referred to in some aspects as “max pooling”), where the largest (e.g., maximum) value for each patch is selected as representative of the patch. Other examples include minimum pooling (also referred to as “min pooling”) where the smallest value is selected for the patch, and average pooling (where the representative value for the patch is the average value of the elements in the patch).

Generally, pooling operations act to downsample the feature map by replacing a set of elements (referred to as a “patch”) in the input tensor with a selected “representative” value (selected based on the type of pooling applied). Patches may generally be any dimensionality (e.g., two-dimensional spatial patches, three-dimensional patches that cross the depth of the tensor, and the like). For example, if a patch includes elements having values of −0.1, 0.7, and 0.3, the maximum pooling operation will select the largest value (0.7), the minimum pooling operation will select the minimum value (−0.1), and the average pooling operation will compute the average value (0.3).

Typical pooling operations can substantially reduce token or feature expressivity. For example, consider two tokens (e.g., two elements of a tensor output by an attention and normalization operation), where the first token indicates no correlation (e.g., a value near 0), and the second token indicates a strong inverse correlation (e.g., a value near −1). If the maximum pooling operation is applied to a patch including the first and second tokens, the operation will select the first token (with a value near 0) over the second token (with a value near −1). However, in some aspects, the second token carries stronger correlation from the attention mechanism regarding how the features are mutually related. In other words, some conventional pooling operations force the model to learn to treat the second token (indicating strong inverse correlation) as less important than a token expressing no correlation at all.

Similar concerns exist with other conventional pooling operations, including minimum pooling (where strong positive correlations may be lost) and average pooling (where strong correlations in either direction are lost). This reduced expressivity of the pooling can substantially reduce model accuracy and performance.

In some aspects of the present disclosure, polarized pooling is introduced. Polarized pooling may be used to replace standard pooling operations (e.g., max pooling and/or average pooling) to maximize (or at least enhance) feature expressivity. In some aspects, polarized pooling may be performed by selecting the element having the largest absolute value in the patch. For example, given tokens with values of −0.5 and 0.4, polarized pooling will generate an output value of −0.5. In this way, polarized pooling retains increased token expressivity, which can enable substantially improved model accuracy in many architectures.

### Example Workflow for Polarized Token Pooling in Machine Learning Models

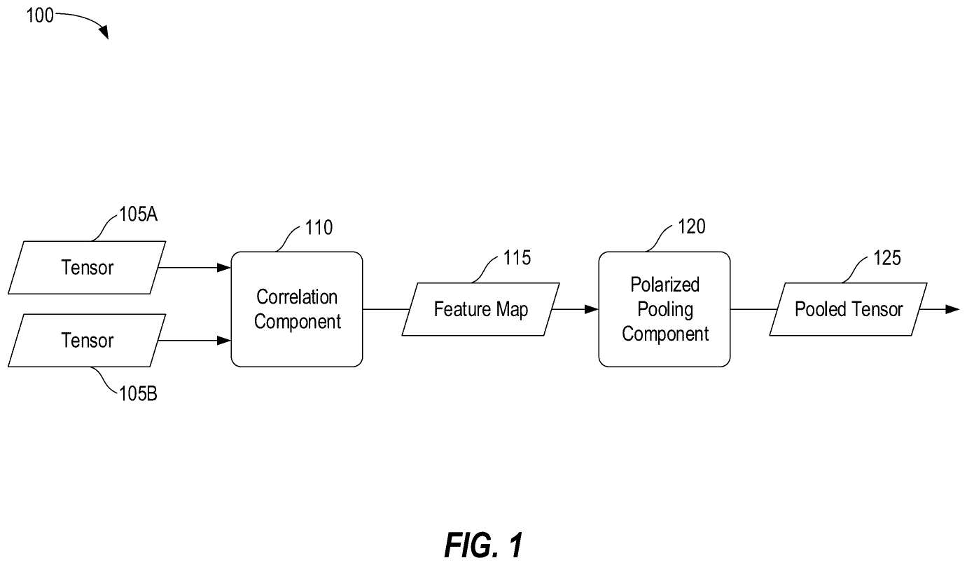

FIG. 1 depicts an example workflow 100 for polarized token pooling in machine learning models, according to some aspects of the present disclosure. In some aspects, the workflow 100 is performed by a machine learning system (e.g., a physical or virtual computing system that uses polarized pooling as part of a machine learning model).

In some aspects, the workflow 100 is used as part of the operations of a machine learning model (e.g., a neural network). For example, the workflow 100 may be used as part of attention operations (e.g., in a transformer block) of an LLM, an LVM, an LMM, a diffusion model, and the like. In the illustrated example, a set of input tensors 105A and 105B are accessed by a correlation component 110 to generate a feature map 115. As used herein, “accessing” data may generally include receiving, requesting, retrieving, obtaining, generating, or otherwise gaining access to the data.

In some aspects, the tensors 105A and 105B (collectively, the tensors 105) correspond to data processed within a machine learning model. For example, the tensors 105 may correspond to activations, input data, output from one or more prior layers, and the like. The tensors 105 are generally representative of any tensors to be compared or correlated (e.g., using attention). Although depicted as discrete tensors 105 for conceptual clarity, in some aspects, the tensors 105 correspond to different portions of a single tensor. For example, in the case of self-attention, the tensors 105 may be different portions of a larger tensor, where the attention is being computed between the two portions of the tensor. Similarly, although two tensors 105 are depicted, the correlation component 110 may generally operate on any number of tensors.

As illustrated, the correlation component 110 processes the tensors 105 to generate a feature map 115. The feature map 115 generally indicates correlation among the input tensors 105. For example, the correlation component 110 may correspond to an attention block (e.g., for self-attention, such as a transformer) that generates attention output (the feature map 115) indicating the amount of correlation among the input tensors 105 (e.g., between different portions of a tensor, between two or more individual tensors, and the like). In some aspects, the correlation component 110 includes or performs a normalization operation, as discussed above. For example, the correlation component 110 may use an NCC operation to generate the feature map 115.

In some aspects, the feature map 115 generally comprises a tensor (e.g., a set of elements arranged in one or more dimensions) where each value (e.g., the value of each element) indicates the correlation between corresponding features or aspects of the tensors 105. For example, in some aspects, the feature map 115 may include values in a range (e.g., [−1,1]), where the lowest value of the defined range (e.g., −1) indicates strong inverse correlation between corresponding elements of the input tensors 105, the highest value (e.g., 1) indicates a strong positive correlation, and the median value (e.g., 0) indicates no correlation.

In the illustrated workflow 100, the feature map 115 is accessed by a polarized pooling component 120 to generate a pooled tensor 125 (referred to in some aspects as a “pooled output” of the polarized pooling operation). In some aspects, as discussed above, the polarized pooling component 120 may be used in place of a conventional pooling operation (e.g., max pooling) in any model architecture. Although depicted as discrete components for conceptual clarity, in some aspects, the operations of the correlation component 110 and the polarized pooling component 120 may be performed by any number and variety of components, and may be implemented using hardware, software, or a combination of hardware and software.

In some aspects, as discussed above, the polarized pooling component 120 selects, for each patch of a set of patches of the feature map 115, a representative value having the highest absolute value of the patch. Generally, as discussed above, the patches (also referred to as “kernels” in some aspects) may be of any size and dimensionality (e.g., (2×2), (2×2×4), (2×4×6), and the like. That is, each patch may cover any number of elements in the feature map 115. In some aspects, the patches may be non-overlapping or overlapping, depending on the particular implementation (e.g., two patches may or may not share any elements of the feature map 115).

The pooled tensor 125 generally includes for each patch in the feature map 115, a selected or representative value. For example, if the feature map has size 4×4 and the patches are non-overlapping 2×2 kernels, the pooled tensor may have size 2×2. The pooled tensor 125 may generally be used for any further processing (e.g., by a subsequent layer of the model, by a subsequent attention operation, and the like).

In some aspects, the polarized pooling operation can preserve more fine-grained details (particularly when cross-resolution attention is performed), as compared to some conventional pooling operations. This can result in substantially improved output. Generally, the techniques described herein can be readily applied in a variety of machine learning models to facilitate a wide variety of tasks, such as feature matching, optical flow analysis, depth estimation (e.g., mono or stereo depth estimation), multi-view synthesis, keypoint tracking, object localization, attention generation, and the like.

For example, in the case of depth estimation, use of the polarized pooling operation can result in substantially improved estimates for fine details depicted in input images, as compared to some conventional approaches. For example, experimentation has shown that polarized pooling can generate accurate depth estimations for fine or narrow objects (e.g., poles and pipes), as compared to some conventional solutions. Polarized pooling also may result in cleaner or sharper depth estimations, even for narrow openings and sharp edges in the images.

Further, in some aspects, polarized pooling may be used to facilitate or perform unlearning in a way that some conventional operations cannot. For example, suppose a model is trained on a large number of classes, and the developers wish to cause the model to forget or unlearn one or more classes (without forgetting the remaining classes). In some aspects, these undesired classes (or other aspects of the output predictions) may be redefined as negative or bad associations in training data. By refining the model (using polarized pooling operations) using this new data, the model may learn to ignore these negative correlations (e.g., to unlearn the undesired classes or other data). In contrast, some conventional approaches (such as max pooling) may simply refrain from learning more based on the new data, but will not “unlearn” the previously learned correlations for the undesired classes.

In these ways, polarized pooling can result in substantially improved machine learning model accuracy and flexibility, as compared to some conventional approaches.

### Example Workflow for Performing Polarized Pooling Using Maximum Pooling Operations

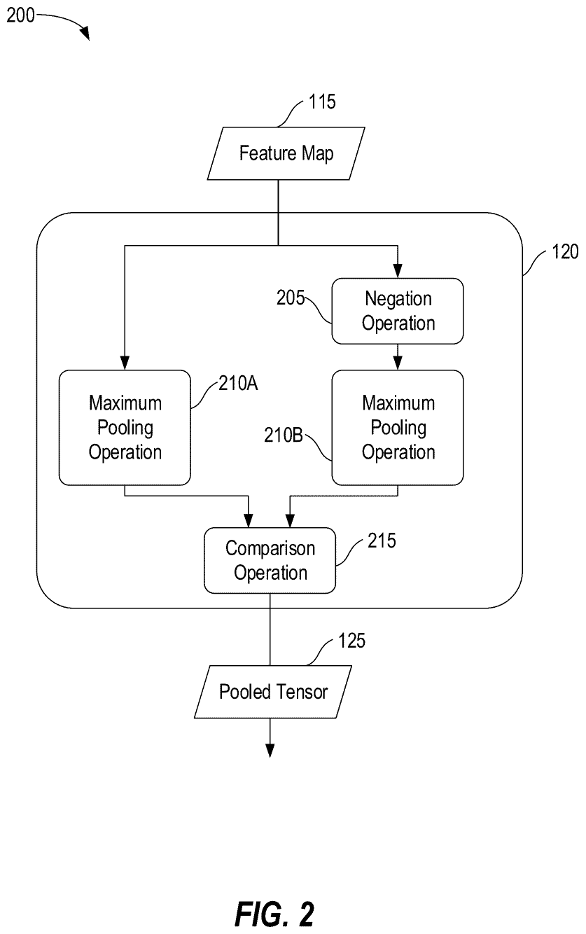

FIG. 2 depicts an example workflow 200 for performing polarized pooling using maximum pooling operations, according to some aspects of the present disclosure. In some aspects, the workflow 200 depicts an example technique for implementing polarized pooling using a set of software operations (e.g., without relying on modifications to the underlying computer hardware, such as a hardware accelerator used to perform machine learning). In some aspects, the workflow 200 is performed by a machine learning system, such as the machine learning system discussed above with reference to FIG. 1 (e.g., a physical or virtual computing system that uses polarized pooling as part of a machine learning model).

In the illustrated example, the feature map 115 is processed by the polarized pooling component 120 to generate a pooled tensor 125, as discussed above. In the depicted workflow 200, the polarized pooling component 120 includes a negation operation 205, two maximum pooling operations 210A and 210B (collectively, the maximum pooling operations 210), and a comparison operation 215. In some aspects, the depicted operations (e.g., the negation operation 205, each maximum pooling operation 210, and the comparison operation 215) may be performed entirely or partially in sequence and/or entirely or partially in parallel. For example, in some aspects, the maximum pooling operations 210A and 210B may be performed in parallel, followed by the comparison operation 215. As another example, in some aspects, the maximum pooling operations 210 may be performed sequentially (e.g., during two passes or cycles) followed by a third pass or cycle for the comparison operation 215.

In the illustrated example, the feature map 115 is accessed by the maximum pooling operation 210A, which generates a pooled tensor that is then provided to the comparison operation 215. In some aspects, the maximum pooling operation 210A may correspond to or implement max pooling, as discussed above. That is, the maximum pooling operation 210A may be used to find, for each patch in the feature map 115, the maximum or largest value (e.g., the largest positive number).

In the illustrated example, the feature map 115 is also accessed by the negation operation 205. The negation operation 205 generally negates each value in the feature map 115 to generate a negated feature map. That is, the negation operation 205 may perform elementwise negation to flip the sign of each value in the feature map 115 (e.g., where positive values become negative values and vice versa).

As illustrated, the negated feature map is then processed by the maximum pooling operation 210B (which may be implemented as a second pass of the same maximum pooling operation 210A) to generate a second pooled tensor. In some aspects, as discussed above, the maximum pooling operation 210B may also correspond to or implement max pooling. That is, the maximum pooling operation 210B may be used to find, for each patch in the feature map 115, the minimum or smallest value (e.g., the most negative number). Although the illustrated example depicts use of a negation operation 205 followed by a maximum pooling operation 210B, in some aspects, the polarized pooling component 120 may alternatively use a minimum pooling operation to replace the negation operation 205 and the maximum pooling operation 210B (e.g., if min pooling is supported by the hardware used to implement the polarized pooling component 120).

In the depicted workflow 200, the two pooled tensors (where the pooled tensor from the maximum pooling operation 210A includes the largest value for each patch and the pooled tensor from the maximum pooling operation 210B includes the smallest value for each patch) are accessed by the comparison operation 215. The comparison operation 215 is generally used to compare the pooled tensors to generate the output pooled tensor 125 for the polarized pooling component 120. For example, the comparison operation 215 may compare each token in the first pooled tensor (output by the maximum pooling operation 210A) with the corresponding token (e.g., the value at the same index) in the second pooled tensor (output by the maximum pooling operation 210B) to determine which is larger.

If the value of the token in the first pooled tensor is larger (e.g., the strongest correlation in the patch is positive), the comparison operation 215 may select this token, from the first pooled tensor, for the corresponding index in the pooled tensor 125. Alternatively, if the value of the token in the second pooled tensor is larger (e.g., the strongest correlation in the patch is negative or inverse), the comparison operation 215 may select this token, from the second pooled tensor, negate the value (to restore the negative sign removed by the negation operation 205), and use this negated value for the corresponding index in the pooled tensor 125. In some aspects, if the values match or are equal, the comparison operation 215 may perform a variety of operations such as selecting either token randomly, selecting a value of zero to indicate no correlation, and the like.

In this way, the pooled tensor 125 includes, for each patch in the feature map 115, the token having the highest absolute value in the feature map 115. As discussed above, this polarized pooling can substantially improve model performance.

### Example Architecture for Performing Polarized Pooling Using Hardware Operations

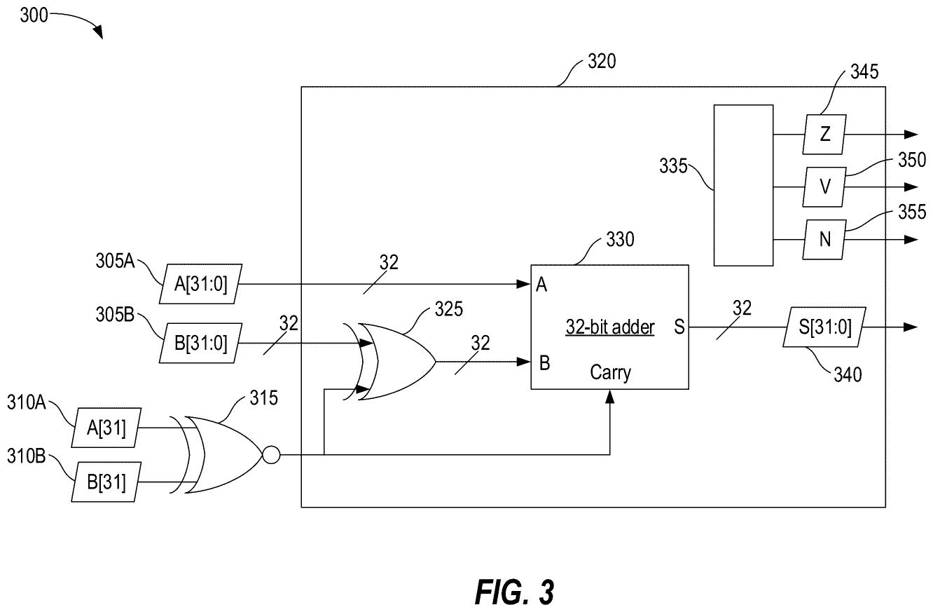

FIG. 3 depicts an example architecture 300 for performing polarized pooling using hardware operations, according to some aspects of the present disclosure. In some aspects, the architecture 300 depicts an example technique for implementing polarized pooling using hardware (e.g., potentially relying on modifications to the hardware accelerator used to perform machine learning). Though the architecture 300 relies on hardware modifications to operate, polarized pooling may generally be performed more efficiently (e.g., with less compute time) using the architecture 300, as compared to using the workflow 200 (which does not rely on hardware modifications). In some aspects, the architecture 300 is used by a machine learning system, such as the machine learning system discussed above with reference to FIGS. 1-2 (e.g., a physical or virtual computing system that uses polarized pooling as part of a machine learning model).

In some aspects, the architecture 300 introduces a small amount of hardware overhead, leveraging existing arithmetic logic unit(s) (ALU(s)) in the hardware processor(s). Specifically, in the illustrated architecture 300, an exclusive NOR (XNOR) gate 315 is added to supplement the existing ALU 320. In some aspects, the inputs 305A and 305B (referred to in some aspects as “operands”) correspond to elements (e.g., tokens) in a feature map (e.g., the feature map 115 of FIGS. 1-2). For example, the inputs 305A and 305B may be two values included within a patch of the feature map 115, where the architecture 300 is being used to perform polarized pooling on the patch. Although two such inputs are depicted, in some aspects, the architecture 300 may be used multiple times (e.g., for each element in the patch) and/or may be duplicated multiple times (e.g., multiple ALUs 320) to allow multiple elements and/or patches to be evaluated in parallel.

In the illustrated example, the ALU 320 receives inputs 305A and 305B (depicted as 32-bit values denoted “A” and “B,” respectively), as well as a control bit (referred to in some aspects as the “ALU function control” or “AFN”) and processes these inputs using an adder 330 (e.g., a 32-bit full adder). Specifically, the inputs 305A and 305B correspond to the data to be processed, and the control bit is provided to the carry input on the adder 330, as well as to an exclusive OR (XOR) gate 325 (e.g., to 32 XOR gates in parallel, one for each bit of the input 305B), to control the operation being performed. For example, a value of zero for the control bit may cause the adder 330 to sum the inputs 305A and 305B, while a value of one may cause the adder 330 to subtract the input 305B from the input 305A.

In some aspects, the compare instruction provided by the ALU 320 may be implemented using a control bit value of one (e.g., to compute A-B). For example, as illustrated, each bit of the input 305B may be processed, along with the control bit, by the XOR gate 325 to generate the second input to the adder 330. The control bit is also used as the carry in value for the adder 330. In this way, a control bit of “one” causes the output 340 to be the result of subtracting the input 305B from the input 305A, while a control bit value of “zero” causes the output 340 to be the result of adding the inputs 305B and 305A.

In the illustrated example, in addition to the output 340, the ALU 320 generates a set of flags 345, 350, and 355 based on the inputs 305A and 305B and the control bit. Although the illustrated architecture 300 depicts the flags 345, 350, and 355 being generated by a discrete component 335 of the ALU 320, in some aspects, these flags 345, 350, and 355 may be set or determined using any suitable components or operations of the ALU 320.

In some aspects, the flag 345 (denoted “Z” in the illustrated example and sometimes referred to as the “zero flag”) indicates whether the output 340 of the ALU 320 is equal to zero (e.g., where a value of one for the flag 345 indicates an output 340 of zero and a value of one for the flag 345 indicates a non-zero output 340). In some aspects, the flag 350 (denoted “V” in the illustrated example and sometimes referred to as the “overflow flag”) indicates whether the output 340 of the ALU 320 resulted in signed overflow. In some aspects, the flag 355 (denoted “N” in the illustrated example and sometimes referred to as the “negative flag”) indicates whether the output 340 of the ALU 320 is negative (e.g., where a value of one for the flag 355 indicates that the output 340 is positive and a value of one for the flag 355 indicates that the output 340 is negative). Although not depicted in the illustrated example, in some aspects, the ALU 320 may produce other flags, such as a carry flag (used to indicate whether the output resulted in a unsigned overflow).

In some aspects, the compare instruction may be implemented using the flag 355. For example, by setting the control bit to “one,” the system may evaluate the negative flag 355 where a value of “one” indicates that the input 305A is smaller than the input 305B (e.g., because A-B is negative) and a value of “zero” indicates that the input 305A is larger than or equal to the input 305B (where the zero flag 345 may be used to differentiate whether the input 305A is greater than the input 305B).

In the illustrated architecture 300, a polarized compare instruction can be implemented using the XNOR gate 315. For example, the sign bits of the two inputs 305A and 305B may be used to determine or set the control bit (e.g., the AFN) as well as to determine how to interpret the flag 345.

Specifically, as illustrated, the sign bit 310A of the input 305A (e.g., the most significant bit) and the sign bit 310B of the input 305B are processed by the XNOR gate 315 to generate the control bit. That is, if both the inputs 305A and 305B are positive (e.g., both sign bits 310A and 310B have a value of “zero”), the control bit will be set to “one” (causing the ALU 320 to subtract the input 305B from the input 305A, as discussed above). If input 305A is positive and the input 305B is negative (e.g., the sign bit 310A has a value of “zero” and the sign bit 310B has a value of “one”), the control bit will be set to “zero” (causing the ALU 320 to add the inputs 305B 305A, as discussed above). If input 305A is negative and the input 305B is positive (e.g., the sign bit 310A has a value of “one” and the sign bit 310B has a value of “zero”), the control bit will be set to “zero” (causing the ALU 320 to add the inputs 305B 305A, as discussed above). If both the inputs 305A and 305B are negative (e.g., both sign bits 310A and 310B have a value of “one”), the control bit will be set to “one” (causing the ALU 320 to subtract the input 305B from the input 305A, as discussed above).

Further, when the negative flag 355 is generated, the system may determine how to interpret the flag 355 based on either or both of the sign bits 310A and 310B. For example, in some aspects, if the input 305A is positive (e.g., the sign bit 310A has a value of “zero”), the output of the polarized pooling operation may be defined using the negative flag 355 (e.g., if the flag 355 has a value of “zero,” the input 305A should be selected, whereas if the flag 355 has a value of “one,” the input 305B should be selected). In some aspects, if the input 305B is positive (e.g., the sign bit 310A has a value of “one”), the output of the polarized pooling operation may be defined using the negation or inversion of the negative flag 355 (e.g., if the flag 355 has a value of “zero,” the input 305B should be selected, whereas if the flag 355 has a value of “one,” the input 305A should be selected). In this way, the output of the polarized pooling operation is the input 305A or 305B having the larger absolute value.

For example, suppose the input 305A has a value of seven and the input 305B has a value of three. As both are positive, the control bit will be set to “one” to cause the adder 330 to subtract three from seven (resulting in an output 340 of four), and the negative flag 355 will be set to “zero” (as the resulting output 340 is positive). The system can therefore select the input 305A for the polarized pooling, as the absolute value of seven is larger than the absolute value of three.

As another example, suppose the input 305A has a value of seven and the input 305B has a value of negative three. The control bit will be set to “zero” to cause the adder 330 to add seven and negative three (resulting in an output 340 of four), and the negative flag 355 will be set to “zero” (as the resulting output 340 is positive). The system can therefore select the input 305A for the polarized pooling, as the absolute value of seven is larger than the absolute value of negative three.

As another example, suppose the input 305A has a value of negative seven and the input 305B has a value of three. The control bit will be set to “zero” to cause the adder 330 to add negative seven and three (resulting in an output 340 of negative four), and the negative flag 355 will be set to “one” (as the resulting output 340 is negative). Because the sign bit 310A is negative, the system can therefore invert the negative flag 355 and select the input 305A for the polarized pooling, as the absolute value of negative seven is larger than the absolute value of three.

As another example, suppose the input 305A has a value of negative seven and the input 305B has a value of negative nine. The control bit will be set to “one” to cause the adder 330 to subtract negative nine from negative seven (resulting in an output 340 of two), and the negative flag 355 will be set to “zero” (as the resulting output 340 is positive). Because the sign bit 310A is negative, the system can therefore invert the negative flag 355 and select the input 305B for the polarized pooling, as the absolute value of negative nine is larger than the absolute value of negative seven.

In this way, the architecture 300 can be efficiently used to perform a polarized pooling operation which, as discussed above, can substantially improve the accuracy of a wide variety of machine learning models for a wide variety of tasks.

### Example Method for Performing Polarized Pooling Using Maximum Pooling Operations

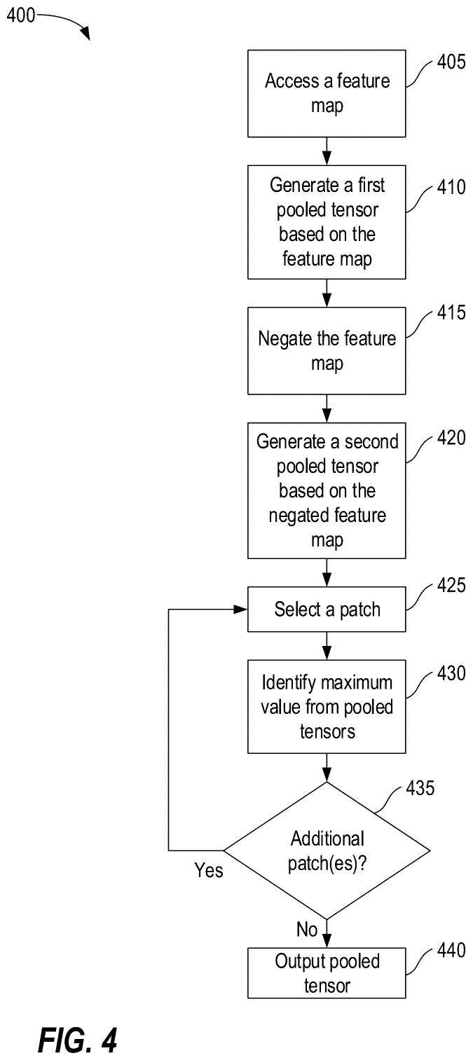

FIG. 4 is a flow diagram depicting an example method 400 for performing polarized pooling using maximum pooling operations, according to some aspects of the present disclosure. In some aspects, the method 400 is performed by a machine learning system, such as the machine learning system discussed above with reference to FIGS. 1-3 (e.g., a physical or virtual computing system that uses polarized pooling as part of a machine learning model). In some aspects, the method 400 provides additional detail for the workflow 200 of FIG. 2.

At block 405, the machine learning system accesses a feature map (e.g., the feature map 115 of FIGS. 1-2). In some aspects, as discussed above, the feature map indicates correlation(s) among two or more tensors (or portions thereof), such as the tensors 105A and 105B of FIG. 1. For example, as discussed above, the feature map may be the result of an attention operation and/or normalization operation (e.g., NCC), as discussed above.

At block 410, the machine learning system generates a first pooled tensor based on the feature map. For example, using the maximum pooling operation 210A of FIG. 2, the machine learning system may apply a max pooling operation to select, for each patch of a set of patches in the feature map, the maximum value of the tokens in the patch. In some aspects, as discussed above, the patches may be defined using any suitable criteria, and each patch may generally cover any number of tokens (from the feature map) across any number of dimensions. In some aspects, the patches are defined based on user-provided hyperparameters (e.g., specifying the size and/or stride of the pooling patches).

At block 415, the machine learning system negates the feature map (e.g., using the negation operation 205 of FIG. 2). For example, as discussed above, the machine learning system may invert or negate each token (e.g., swapping the sign of each value) in the feature map.

At block 420, the machine learning system generates a second pooled tensor based on the negated feature map. For example, using the maximum pooling operation 210B of FIG. 2, the machine learning system may apply a max pooling operation to select, for each patch of a set of patches in the negated feature map, the maximum (negated) value of the tokens in the patch. In some aspects, the second pooled tensor may be generated using the same patch definitions as the first pooled tensor map, such that each index in the first pooled tensor has a one-to-one correspondence with an index in the second pooled tensor. In some aspects, as discussed above, the desired output of the polarization pooling operation may similarly have a one-to-one correspondence with the pooled tensors.

At block 425, the machine learning system selects a patch from the feature map. Stated differently, the machine learning system may select an index (e.g., an element) in the first and second pooled tensors and/or in the desired output tensor. Generally, the machine learning system may select the patch or index using any suitable criteria, including randomly or pseudo-randomly, as all such patches or indices will be processed during the method 400.

At block 430, the machine learning system identifies the maximum value for the selected match or index, from the first and second pooled tensors. That is, the machine learning system determines whether value of the token at the selected index (e.g., for the selected patch) in the first pooled tensor (generated at block 410 based on max pooling of the feature map) or the value of the token at the selected index (e.g., for the selected patch) in the second pooled tensor (generated at block 420 based on max pooling of the negated feature map) is greater.

In some aspects, as discussed above, if the token in the first pooled tensor has a greater value, the machine learning system selects this token (from the first pooled tensor) as the output token in the output pooled tensor for the selected index (or patch). If the token in the second pooled tensor has the greater value, the machine learning system may invert or negate this token (from the second pooled tensor) as the output token for the output pooled tensor for the selected index.

At block 435, the machine learning system determines whether there is at least one additional patch in the feature map (e.g., at least one additional index in the pooled tensors) which has not yet been processed. If so, the method 400 returns to block 425. If not, the method 400 continues to block 440. Although the illustrated example depicts a sequential process (e.g., selecting and evaluating each index or patch iteratively) for conceptual clarity, in some aspects, the machine learning system may process some or all of the patches (or indices) in parallel.

At block 440, the machine learning system outputs the pooled tensor (e.g., the pooled tensor 125 of FIGS. 1-2) as output from the polarized pooling operation. In some aspects, as discussed above, this output pooled tensor may be used as output from the machine learning model itself, or may be used as input to a variety of other operations, such as one or more layers (e.g., convolutions or linear layers) of the machine learning model, one or more transformers or other attention blocks, and the like.

### Example Method for Performing Polarized Pooling Using Hardware

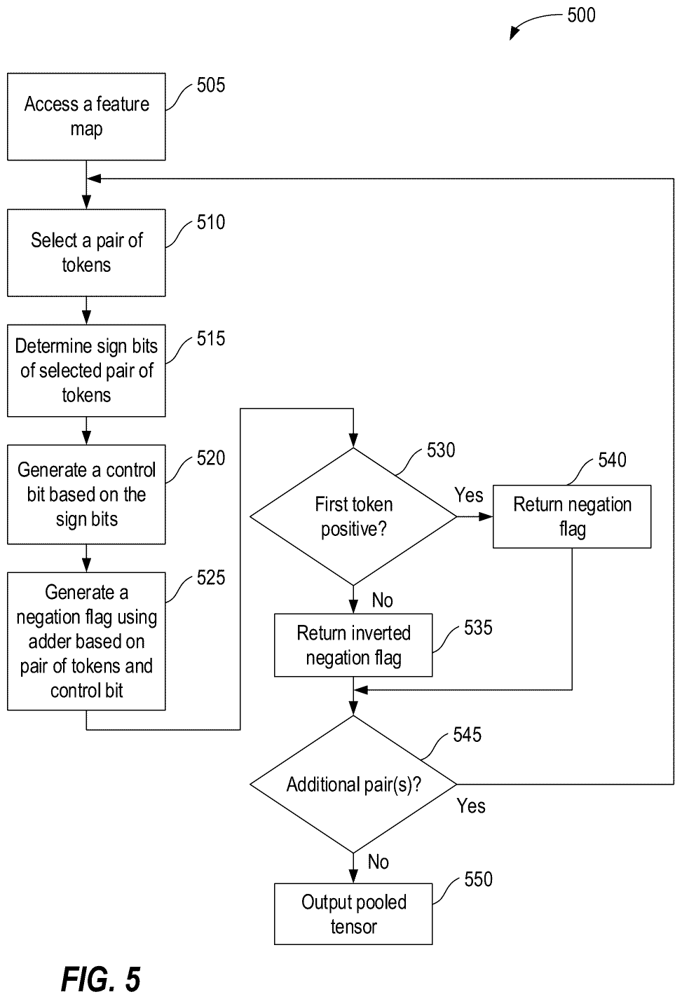

FIG. 5 is a flow diagram depicting an example method 500 for performing polarized pooling using hardware, according to some aspects of the present disclosure. In some aspects, the method 500 is performed by a machine learning system, such as the machine learning system discussed above with reference to FIGS. 1-4 (e.g., a physical or virtual computing system that uses polarized pooling as part of a machine learning model). In some aspects, the method 500 provides additional detail for processing data using the architecture 300 of FIG. 3.

At block 505, the machine learning system accesses a feature map (e.g., the feature map 115 of FIGS. 1-2). In some aspects, as discussed above, the feature map indicates correlation(s) among two or more tensors (or portions thereof), such as the tensors 105A and 105B of FIG. 1. For example, as discussed above, the feature map may be the result of an attention operation and/or normalization operation (e.g., NCC), as discussed above.

At block 510, the machine learning system selects a pair of tokens (e.g., the inputs 305A and 305B of FIG. 3) from a given patch in the feature map. Generally, the machine learning system may select the pair of tokens using any suitable criteria or technique, including randomly or pseudo randomly, as the machine learning system may evaluate all tokens in the patch (as well as each patch) during the method 500.

At block 515, the machine learning system determines the sign bits (e.g., the sign bits 310A and 310B of FIG. 3) of each of the selected pair of tokens.

At block 520, the machine learning system generates a control bit (e.g., the AFN) based on the sign bits. For example, as discussed above, the machine learning system may process the sign bits using an XNOR gate (e.g., the XNOR gate 315 of FIG. 3). For example, as discussed above, the machine learning system may set the control bit to “one” if both sign bits have a value of “zero” (e.g., indicating that both the tokens are positive) or if both sign bits have a value of “one” (e.g., indicating that both the tokens are negative). Similarly, the machine learning system may the control bit to “zero” if the sign bits differ (e.g., if the pair of tokens have opposite signs).

At block 525, the machine learning system generates a value for a negation flag (e.g., the negative flag 355 of FIG. 3) using an adder based on the pair of tokens and the control bit. For example, as discussed above, the machine learning system may provide the tokens and the control bit as input to the adder (e.g., the adder 330 of FIG. 3), and a corresponding negation flag may be generated based on the output of the adder.

At block 530, the machine learning system determines whether the first token (of the selected pair of tokens) is positive (e.g., whether the sign bit of the first token is zero or one). If the first token is positive, the method 500 continues to block 540, where the machine learning system returns the negation flag to drive the polarized pooling operation. That is, as discussed above, the machine learning system determines that the absolute value of the first token is greater than the absolute value of the second token, and therefore determines that the second token should not be selected for the current patch of the pooling operation. In some aspects, this comparison may be performed between pairs of tokens in the patch until all tokens have been included in at least one evaluation (e.g., until the token having the largest absolute value is found). The method 500 then proceeds to block 545.

If, at block 530, the machine learning system determines that the first token is negative, the method 500 proceeds to block 535, where the machine learning system returns the inverted negation flag to drive the polarized pooling operation. That is, as discussed above, the machine learning system determines that the absolute value of the second token is greater than the absolute value of the first token, and therefore determines that the first token should not be selected for the current patch of the pooling operation. The method 500 then proceeds to block 545.

At block 545, the machine learning system determines whether there is at least one pair of tokens (or at least one individual token) in the given patch that has not yet been evaluated. If so, the method 500 returns to block 510 to select another pair of tokens (e.g., including the token selected at blocks 540 or 545, and a new token not yet processed). If all tokens or pairs in the patch have been evaluated, the machine learning system can use the token having the highest absolute value as the output for the pooled tensor, as discussed above.

Although the illustrated example depicts a sequential process (e.g., selecting and evaluating each pair of tokens iteratively) for conceptual clarity, in some aspects, the machine learning system may process some or all of the tokens in a given patch, as well as some or all of the patches in the feature map, in parallel.

At block 550, the machine learning system outputs the pooled tensor (e.g., the pooled tensor 125 of FIGS. 1-2) as output from the polarized pooling operation. In some aspects, as discussed above, this output pooled tensor may be used as output from the machine learning model itself, or may be used as input to a variety of other operations, such as one or more layers (e.g., convolutions or linear layers) of the machine learning model, one or more transformers or other attention blocks, and the like.

### Example Method for Polarized Pooling

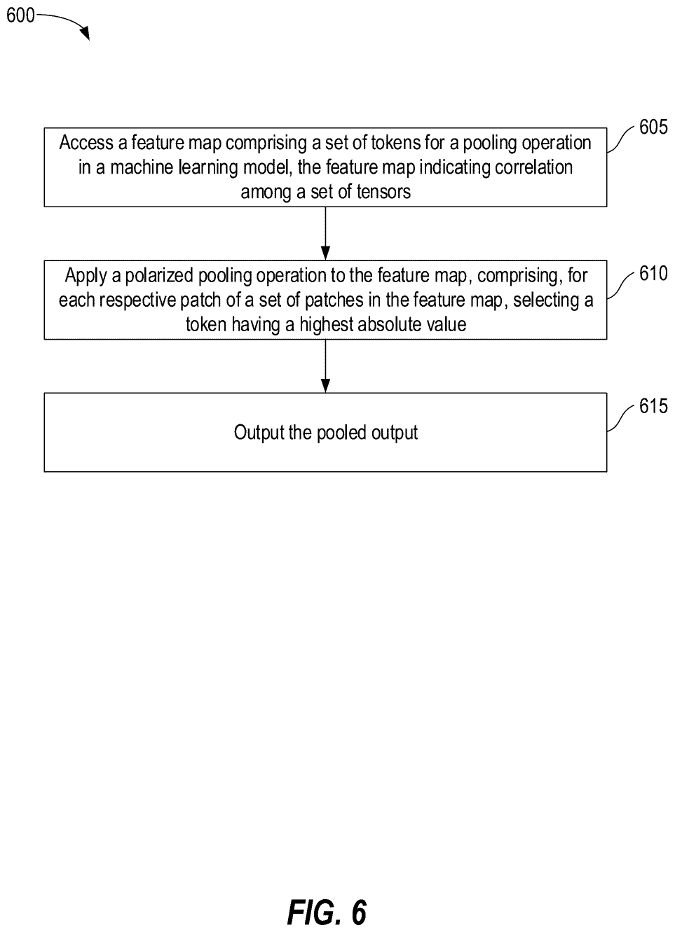

FIG. 6 is a flow diagram depicting an example method 600 for polarized pooling, according to some aspects of the present disclosure. In some aspects, the method 600 is performed by a machine learning system, such as the machine learning system discussed above with reference to FIGS. 1-5 (e.g., a physical or virtual computing system that uses polarized pooling as part of a machine learning model).

At block 605, a feature map comprising a set of tokens is accessed for a pooling operation in a machine learning model, the feature map indicating correlation among a set of tensors.

At block 610, a polarized pooling operation is applied to the feature map to generate a pooled output, comprising, for each respective patch of a set of patches in the feature map, selecting a token, in the respective patch, having a highest absolute value.

At block 615, the pooled output is output.

In some aspects, the method 600 further includes generating the feature map using a normalized cross-correlation (NCC) operation on the set of tensors.

In some aspects, the set of tokens comprises values within a defined range, a highest value of the defined range indicates a strong correlation among one or more elements of the set of tensors, a lowest value of the defined range indicates a strong inverse correlation among one or more elements of the set of tensors, and a median value of the defined range indicates no correlation among one or more elements of the set of tensors.

In some aspects, the method 600 further comprises: generating a first pooled tensor based on processing the feature map using a maximum pooling operation, negating the feature map, generating a second pooled tensor based on processing the negated feature map using the maximum pooling operation, and generating the pooled output based on comparing, for each respective patch of the set of patches, a corresponding value in the first pooled tensor and a corresponding value in the second pooled tensor.

In some aspects, the method 600 further comprises, for the first patch of the set of patches: generating a value for a control bit based on a first sign bit of a first token in the first patch and a second sign bit of a second token in the first patch, processing the first and second tokens using an adder, based on the value for the control bit, to generate a value for a flag, determining whether to invert the value of the flag based on the first and second sign bits, and selecting the token for the first patch based on the value of the flag.

In some aspects, generating the value for the control bit comprises applying an exclusive NOR (XNOR) operation to the first and second sign bits.

In some aspects, determining whether to invert the value of the flag comprises, in response to determining that the first sign bit is positive, refraining from inverting the value of the flag.

In some aspects, determining whether to invert the value of the flag comprises, in response to determining that the first sign bit is negative, inverting the value of the flag.

In some aspects, the pooling operation is applied in the machine learning model to facilitate at least one of: (i) feature matching, (ii) optical flow analysis, (iii) depth estimation, (iv) multi-view synthesis, (v) keypoint tracking, (vi) object localization, (vii) attention generation, or (viii) unlearning for the machine learning model.

### Example Processing System for Polarized Pooling

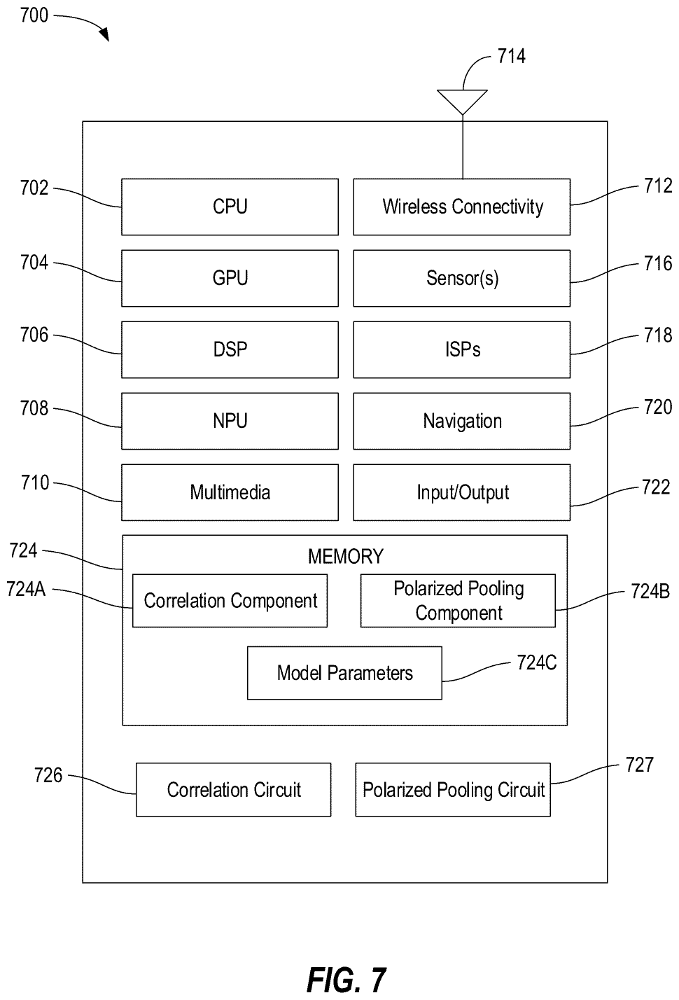

FIG. 7 depicts an example processing system 700 configured to perform various aspects of the present disclosure, including, for example, the techniques and methods described with respect to FIGS. 1-6. In some aspects, the processing system 700 may correspond to a machine learning system. For example, the processing system 700 may correspond to the machine learning system discussed above with reference to FIGS. 1-6. Although depicted as a single system for conceptual clarity, in some aspects, as discussed above, the components described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of a memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as the NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a correlation component 724A and a polarized pooling component 724B. Although not depicted in the illustrated example, the memory 724 may also include other components, such as an inferencing or generation component to manage the generation of output predictions using trained machine learning models, a training component used to train or update the machine learning model(s), and the like. Though depicted as discrete components for conceptual clarity in FIG. 7, the illustrated components (and others not depicted) may be collectively or individually implemented in various aspects.

As illustrated, the memory 724 also includes a set of model parameters 724C (e.g., parameters of one or more machine learning models, such as weights and/or biases, used to generate model output). For example, as discussed above, the model parameters 724C may include learned parameters for an attention-based machine learning model (e.g., a model that uses attention and/or normalization operations). Although not depicted in the illustrated example, the memory 724 may also include other data such as training data.

The processing system 700 further comprises a correlation circuit 726 and a polarized pooling circuit 727. The depicted circuits, and others not depicted (such as an inferencing circuit), may be configured to perform various aspects of the techniques described herein.

The correlation component 724A and/or the correlation circuit 726 (which may correspond to the correlation component 110 of FIG. 1) may be used to generate feature maps (e.g., the feature map 115 of FIGS. 1-2) indicating correlations between input tensors (or portions thereof), as discussed above. For example, the correlation component 724A and/or the correlation circuit 726 may use self-attention to generate the feature map based on a single tensor (e.g., indicating correlations between different parts of the tensor) and/or between multiple discrete tensors.

The polarized pooling component 724B and/or the polarized pooling circuit 727 (which may correspond to the polarized pooling component 120 of FIGS. 1-2) may be used to apply polarized pooling operations to feature maps, as discussed above. For example, the polarized pooling component 724B and/or the polarized pooling circuit 727 may use the workflow 200 of FIG. 2 and/or the architecture 300 of FIG. 3 to generate pooled tensors using polarized pooling. As discussed above, polarized pooling generally includes selecting, for each respective patch of the feature map, a respective token (from the patch) having the highest absolute value.

Though depicted as separate components and circuits for clarity in FIG. 7, the correlation circuit 726 and the polarized pooling circuit 727 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, aspects of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 maybe distributed between multiple devices.

### Example Clauses

Implementation examples are described in the following numbered clauses:

Clause 1: A method, comprising: accessing a feature map comprising a set of tokens for a pooling operation in a machine learning model, the feature map indicating correlation among a set of tensors; applying a polarized pooling operation to the feature map to generate a pooled output, comprising, for each respective patch of a set of patches in the feature map, selecting a token, in the respective patch, having a highest absolute value; and outputting the pooled output.

Clause 2: A method according to Clause 1, further comprising generating the feature map using a normalized cross-correlation (NCC) operation on the set of tensors.

Clause 3: A method according to any of Clauses 1-2, wherein: the set of tokens comprises values within a defined range, a highest value of the defined range indicates a strong correlation among one or more elements of the set of tensors, a lowest value of the defined range indicates a strong inverse correlation among one or more elements of the set of tensors, and a median value of the defined range indicates no correlation among one or more elements of the set of tensors.

Clause 4: A method according to any of Clauses 1-3, wherein applying the polarized pooling operation comprises: generating a first pooled tensor based on processing the feature map using a maximum pooling operation; negating the feature map; generating a second pooled tensor based on processing the negated feature map using the maximum pooling operation; and generating the pooled output based on comparing, for each respective patch of the set of patches, a corresponding value in the first pooled tensor and a corresponding value in the second pooled tensor.

Clause 5: A method according to any of Clauses 1-3, wherein applying the polarized pooling operation comprises, for a first patch of the set of patches: generating a value for a control bit based on a first sign bit of a first token in the first patch and a second sign bit of a second token in the first patch; processing the first and second tokens using an adder, based on the value for the control bit, to generate a value for a flag; determining whether to invert the value of the flag based on the first and second sign bits; and selecting the token for the first patch based on the value of the flag.

Clause 6: A method according to Clause 5, wherein generating the value for the control bit comprises applying an exclusive NOR (XNOR) operation to the first and second sign bits.

Clause 7: A method according to any of Clauses 5-6, wherein determining whether to invert the value of the flag comprises, in response to determining that the first sign bit is positive, refraining from inverting the value of the flag.

Clause 8: A method according to any of Clauses 5-6, wherein determining whether to invert the value of the flag comprises, in response to determining that the first sign bit is negative, inverting the value of the flag.

Clause 9: A method according to any of Clauses 1-8, wherein the pooling operation is applied in the machine learning model to facilitate at least one of: (i) feature matching, (ii) optical flow analysis, (iii) depth estimation, (iv) multi-view synthesis, (v) keypoint tracking, (vi) object localization, (vii) attention generation, or (viii) unlearning for the machine learning model.

Clause 10: A processing system comprising: a memory comprising computer-executable instructions; and one or more processors coupled to the one or more memories and configured to execute the computer-executable instructions and cause the processing system to perform a method in accordance with any of Clauses 1-9.

Clause 11: A processing system comprising means for performing a method in accordance with any of Clauses 1-9.

Clause 12: A non-transitory computer-readable medium comprising computer-executable instructions that, when executed by one or more processors of a processing system, cause the processing system to perform a method in accordance with any of Clauses 1-9.

Clause 13: A computer program product embodied on a computer-readable storage medium comprising code for performing a method in accordance with any of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a feature map comprising a set of tokens for a pooling operation in a machine learning model, the feature map indicating correlation among a set of tensors;
apply a polarized pooling operation to the feature map to generate a pooled output, wherein, to generate the pooled output, the one or more processors are configured to execute the processor-executable instructions and cause the processing system to, for each respective patch of a set of patches in the feature map, select a token, in the respective patch, having a highest absolute value; and
output the pooled output.

2. The processing system of claim 1, wherein the one or more processors are configured to further execute the processor-executable instructions and cause the processing system to generate the feature map using a normalized cross-correlation (NCC) operation on the set of tensors.

3. The processing system of claim 1, wherein:
the set of tokens comprises values within a defined range,
a highest value of the defined range indicates a strong correlation among one or more elements of the set of tensors,
a lowest value of the defined range indicates a strong inverse correlation among one or more elements of the set of tensors, and
a median value of the defined range indicates no correlation among one or more elements of the set of tensors.

4. The processing system of claim 1, wherein, to apply the polarized pooling operation, the one or more processors are configured to execute the processor-executable instructions and cause the processing system to:
generate a first pooled tensor based on processing the feature map using a maximum pooling operation;
negate the feature map;
generate a second pooled tensor based on processing the negated feature map using the maximum pooling operation; and
generate the pooled output based on comparing, for each respective patch of the set of patches, a corresponding value in the first pooled tensor and a corresponding value in the second pooled tensor.

5. The processing system of claim 1, wherein, to apply the polarized pooling operation, the one or more processors are configured to execute the processor-executable instructions and cause the processing system to, for a first patch of the set of patches:
generate a value for a control bit based on a first sign bit of a first token in the first patch and a second sign bit of a second token in the first patch;
process the first and second tokens using an adder, based on the value for the control bit, to generate a value for a flag;
determine whether to invert the value of the flag based on the first and second sign bits; and
select the token for the first patch based on the value of the flag.

6. The processing system of claim 5, wherein, to generate the value for the control bit, the one or more processors are configured to execute the processor-executable instructions and cause the processing system to apply an exclusive NOR (XNOR) operation to the first and second sign bits.

7. The processing system of claim 5, wherein, to determine whether to invert the value of the flag, the one or more processors are configured to execute the processor-executable instructions and cause the processing system to, in response to determining that the first sign bit is positive, refrain from inverting the value of the flag.

8. The processing system of claim 5, wherein, to determine whether to invert the value of the flag, the one or more processors are configured to execute the processor-executable instructions and cause the processing system to, in response to determining that the first sign bit is negative, invert the value of the flag.

9. The processing system of claim 1, wherein the pooling operation is applied in the machine learning model to facilitate at least one of:
(i) feature matching,
(ii) optical flow analysis,
(iii) depth estimation,
(iv) multi-view synthesis,
(v) keypoint tracking,
(vi) object localization,
(vii) attention generation, or
(viii) unlearning for the machine learning model.

10. A processor-implemented method for feature pooling in machine learning models, comprising:
accessing a feature map comprising a set of tokens for a pooling operation in a machine learning model, the feature map indicating correlation among a set of tensors;
applying a polarized pooling operation to the feature map to generate a pooled output, comprising, for each respective patch of a set of patches in the feature map, selecting a token, in the respective patch, having a highest absolute value; and
outputting the pooled output.

11. The processor-implemented method of claim 10, further comprising generating the feature map using a normalized cross-correlation (NCC) operation on the set of tensors.

12. The processor-implemented method of claim 10, wherein:
the set of tokens comprises values within a defined range,
a highest value of the defined range indicates a strong correlation among one or more elements of the set of tensors,
a lowest value of the defined range indicates a strong inverse correlation among one or more elements of the set of tensors, and
a median value of the defined range indicates no correlation among one or more elements of the set of tensors.

13. The processor-implemented method of claim 10, wherein applying the polarized pooling operation comprises:
generating a first pooled tensor based on processing the feature map using a maximum pooling operation;
negating the feature map;
generating a second pooled tensor based on processing the negated feature map using the maximum pooling operation; and
generating the pooled output based on comparing, for each respective patch of the set of patches, a corresponding value in the first pooled tensor and a corresponding value in the second pooled tensor.

14. The processor-implemented method of claim 10, wherein applying the polarized pooling operation comprises, for a first patch of the set of patches:
generating a value for a control bit based on a first sign bit of a first token in the first patch and a second sign bit of a second token in the first patch;
processing the first and second tokens using an adder, based on the value for the control bit, to generate a value for a flag;
determining whether to invert the value of the flag based on the first and second sign bits; and
selecting the token for the first patch based on the value of the flag.

15. The processor-implemented method of claim 14, wherein generating the value for the control bit comprises applying an exclusive NOR (XNOR) operation to the first and second sign bits.

16. The processor-implemented method of claim 14, wherein determining whether to invert the value of the flag comprises, in response to determining that the first sign bit is positive, refraining from inverting the value of the flag.

17. The processor-implemented method of claim 14, wherein determining whether to invert the value of the flag comprises, in response to determining that the first sign bit is negative, inverting the value of the flag.

18. The processor-implemented method of claim 10, wherein the pooling operation is applied in the machine learning model to facilitate at least one of:
(i) feature matching,
(ii) optical flow analysis,
(iii) depth estimation,
(iv) multi-view synthesis,
(v) keypoint tracking,
(vi) object localization,
(vii) attention generation, or
(viii) unlearning for the machine learning model.

19. A processing system, comprising:
means for accessing a feature map comprising a set of tokens for a pooling operation in a machine learning model, the feature map indicating correlation among a set of tensors;
means for applying a polarized pooling operation to the feature map to generate a pooled output, comprising means for, for each respective patch of a set of patches in the feature map, selecting a token, in the respective patch, having a highest absolute value; and
means for outputting the pooled output.

20. The processing system of claim 19, wherein the means for applying the polarized pooling operation comprise, for a first patch of the set of patches:
means for generating a value for a control bit based on a first sign bit of a first token in the first patch and a second sign bit of a second token in the first patch;
means for processing the first and second tokens using an adder, based on the value for the control bit, to generate a value for a flag;
means for determining whether to invert the value of the flag based on the first and second sign bits; and
means for selecting the token for the first patch based on the value of the flag.
